(19) United States
(12) Patent Application Publication
(10) Pub. No.: US 2001/0031639 A1
(43) Pub. Date: Oct. 18, 2001

(54) Method in wireless telecommunication system, system, transmitter and receiver

(76) Inventor: Risto Makipaa, Otava (FI)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/800,750

(22) Filed: Mar. 7, 2001

Related U.S. Application Data
(63) Continuation of application No. PCT/FI99/00725, filed on Sep. 7, 1999.

(30) Foreign Application Priority Data
Sep. 8, 1998 (FI) 981923

(51) Int. Cl. H04Q 7/20

(52) U.S. Cl. 455/450; 455/509; 455/517

(57) ABSTRACT

A method in a wireless telecommunication system using code division multiple access technology, which system comprises a telecommunication switching center, a transmitter and a receiver, in which method the telecommunication switching center defines an identifier for the transmitter on the basis of the location of the transmitter and the transmitter defines a traffic channel identifier for the radio link traffic channel between said transmitter and said receiver on the basis of the location of the receiver. In the system, the channels of the radio link between the transmitter and the receiver are distinguished from each other by code sequences, and the code sequences used are defined according to the location information of the transmitter and the receiver. The definition of the location information of the transmitter and the receiver is performed by means of a satellite positioning system.

### BACKGROUND

This invention claims priority to co-pending International Patent Application No. PCT/FI99/00725, filed on Sep. 7, 1999, which in turn claims priority to Finland Patent Application No. 981923, filed on Sep. 8, 1988 the specifications of each of which are incorporated herein by reference.

1. Field of the Invention

The invention relates to a method in a wireless telecommunication system using code division multiple access technology, which system comprises a telecommunication switching center, a transmitter and a receiver, in which method an identifier is defined for the transmitter and a traffic channel identifier is defined for the radio link traffic channel between said transmitter and said receiver, and in which method the channels of the radio link between the transmitter and the receiver are distinguished from each other by means of code sequences. The invention also relates to a wireless telecommunication system using code division multiple access technology, which system comprises a telecommunication switching center, a transmitter and a receiver, in which system the telecommunication switching center defines an identifier for the transmitter and which transmitter defines a traffic channel identifier for the radio link traffic channel between said transmitter and said receiver, and in which system the channels of the radio link between the transmitter and the receiver are distinguished from each other by means of code sequences. Further, the invention relates to a transmitter and a receiver utilized in the system.

2. Description of the Art

To maximize the number of possible concurrent users and, at the same time, to provide a reliable telecommunication link, wireless telecommunication systems use various multiple access methods for allocating radio path resources for users. These include FDMA (Frequency Division Multiple Access), TDMA (Time Division Multiple Access) and CDMA (Code Division Multiple Access). In third-generation mobile systems, the CDMA, i.e. code division multiple access, technology is generally used; it is a multiple access method using spread-spectrum technology, in which a baseband signal is modulated with a code sequence before carrier modulation. Users are distinguished from each other by means of this code sequence. The possibilities to also apply CDMA technology to other wireless data transmission areas are continuously studied.

In CDMA technology, only one frequency, but a wide bandwidth is used in the one-way data transmission between the transmitter and the receiver. The bandwidth of a baseband signal is increased considerably by modulating it with a code sequence. The code sequences used are pseudo-random noise sequences, i.e. the code sequences resemble random noise, but are, however, deterministic. The code sequences are also almost completely orthogonal in relation to each other. Increasing the bandwidth of the signal compensates for the interference caused by noise, multipath propagation and data transmission links of other users. A frequency channel allocated according to the principles of the spread-spectrum technology is made available for all users simultaneously, and, at the same time, the transmission power used is controlled and limited. A wideband signal being transmitted resembles background noise, but a receiver which knows the correct code sequence can find from the background noise the signal meant for it and from which the original message can be produced by demodulation.

For the transmitter and the receiver to be able to communicate with each other, both need to know the code sequence used in the link. The code sequences are generated from code masks, i.e. from long binary digits created according to certain rules. The code masks are processed with logical operators using certain algorithms and the result is a periodic code sequence. Since the number of code sequences available is limited and since the transmitter coverage areas, i.e. cells, overlap partly, transmitters using the same code sequences must be located far enough from each other. Each transmitter communicates with receivers within the area of its own cell using traffic channels according to the CDMA system, which are all defined their own code sequences on the basis of the code mask. The code sequence used is communicated to the receiver through synchronization channels. The procedure described above makes optimal network design difficult, because the design must take into account the cell size, the transmission power used, the number of code sequences, the number of various services, the area coverage of the cellular network, and the overlapping of the cells, etc.

The procedure described above makes network management difficult especially in a situation where it would be useful to use a mobile transmitter to provide local services. In future wireless telecommunication networks, such as the mobile networks, the need to provide local services will increase; for instance, there is a need to provide customer services related to a large local public event locally through a public land mobile network. In such a case, a mobile base station creates, in most cases, an overlapping cell with the already existing fixed cell, and network management and handover decisions become more difficult. Further, the known method for defining code sequences slows down the installation of a network in new areas, because the code masks used and thus also the code sequences must be carefully planned so as not to produce overlapping with the already existing local area code sequences.

### SUMMARY OF THE INVENTION

It is an object of this invention to create a method with which the transmitter, the traffic channel between the transmitter and receiver and the code mask defined using them are defined individually. It is a further object of the invention to create a telecommunication system utilizing the method, in which the disadvantages described above are avoided.

The method of the invention is characterized in that

the code sequences used on the radio link channels are defined on the basis of the location information of the transmitter and the receiver.

The wireless telecommunication system of the invention is characterized in that

the code sequences used on the radio link channels have been defined on the basis of the location information of the transmitter and the receiver.

The transmitter of the invention is characterized in that

the transmitter is arranged to define its own location and that

the transmitter is arranged to receive the location information of the receiver and that

the transmitter is arranged to define the code sequence of the radio link between the transmitter and the receiver on the basis of the location information of the transmitter and receiver.

The receiver of the invention is characterized in that

the receiver is arranged to define its own location and that

the receiver is arranged to transmit its location information to the transmitter.

The essential idea of the invention is that the data transmission parameters of the apparatuses belonging to the telecommunication system are defined on the basis of the location of the apparatuses. Further, the idea of one preferred embodiment of the invention is that a long-code mask according to the CDMA technology is defined by means of these data transmission parameters. A yet further idea of one preferred embodiment of the invention is that satellite positioning is used to define the location of the apparatuses.

The invention provides the advantage that the method of the invention facilitates network management and network design especially in a situation where mobile or temporary base stations need to be added to the base station system. A further advantage of the invention is that the method of the invention creates a different long-code mask for each link between the transmitter and the receiver, which means that the code sequence used on the link is also unique. A yet further advantage of the invention is that by utilizing the method of the invention, a network or local parts of it can be installed quickly.

### DESCRIPTION OF THE FIGURES

In the following, the invention will be described in greater detail with reference to the accompanying drawings in which

FIG. 1 shows a simplified block diagram of the structure of a mobile system,

FIG. 2 shows a simplified block diagram of the code channel structure of a forward CDMA channel according to the IS-95 system,

FIG. 3 shows a general bit format of the long-code mask in the IS-95 system,

FIG. 4 shows an exemplary flow chart illustrating the definition of a transmitter identifier performed by a telecommunication switching center in accordance with a preferred embodiment of the invention,

FIG. 5 shows an exemplary flow chart illustrating the definition of an identifier for a traffic channel on the radio path between the transmitter and the receiver performed by a transmitter in accordance with a preferred embodiment of the invention.

### DESCRIPTION OF THE INVENTION

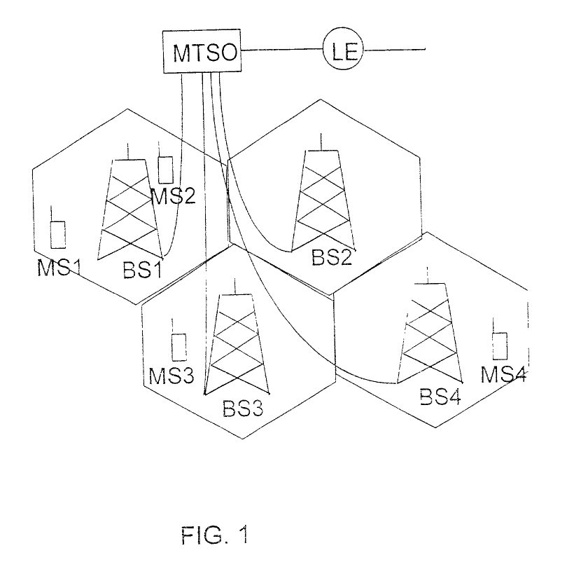

FIG. 1 shows the general structure of a mobile network used in the invention. Mobile stations (MS1 to MS4) are connected to base stations (BS1 to BS4) over a radio path. The base stations BS1 to BS4 are connected to a mobile telephone switching office (MTSO) usually through a wired connection, but the connection can also be wireless. The mobile telephone switching office is connected to a public telephone network (not shown) through a local exchange (LE). The general structure of a mobile network is known to persons skilled in the art and thus it is not necessary to describe it in greater detail herein.

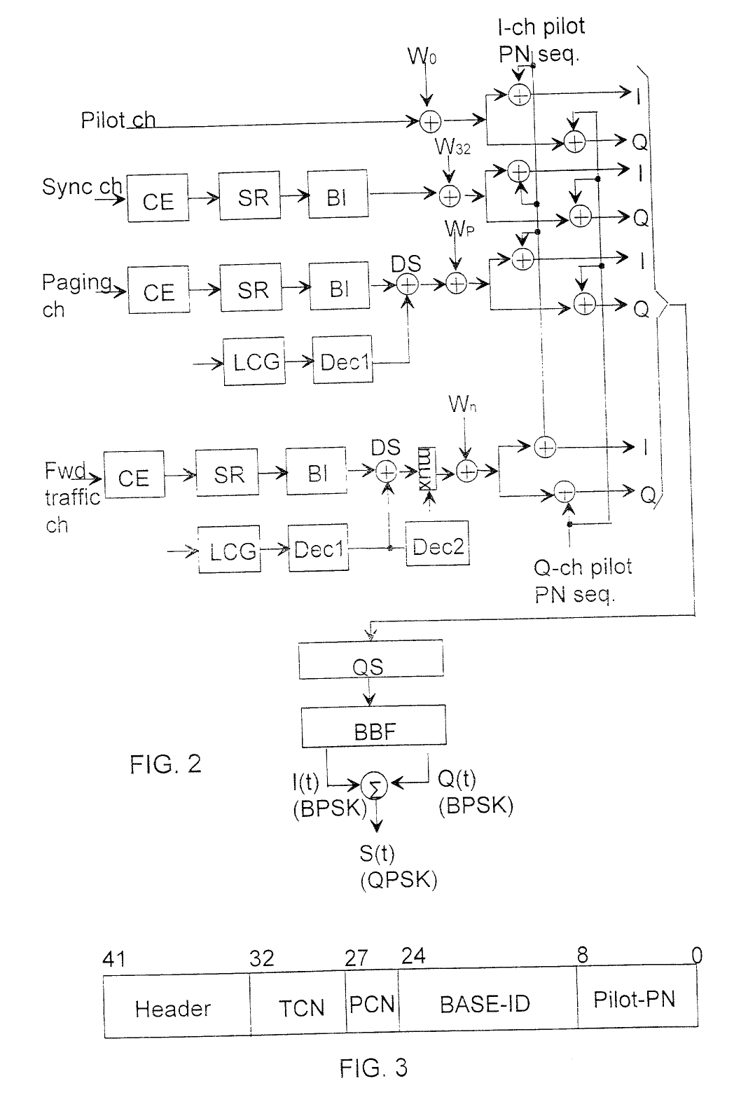

In the following, the invention will be described by way of example in greater detail on the basis of FIGS. 2 and 3 with reference to the CDMA system (IS-95) used in mobile networks. It is obvious that the invention is not restricted to mobile networks only, but can be applied to any wireless telecommunication system within the scope of the accompanying claims.

In the system in question, one base station signals on one forward CDMA channel to several mobile stations. One forward CDMA channel comprises 64 code channels, of which, according to a typical arrangement, code channel W₀ is reserved as a pilot channel and W₃₂ is reserved as a synchronization channel, code channels W₁ to W₇ are reserved as paging channels (Wₚ) and the remaining 55 code channels can be used as forward traffic channels (Wₙ). Pilot channels transmit continuously unmodulated, logical 0 data which mobile stations use for timing and to find the correct demodulation phase reference. The data on the other code channels is channel-coded in a convolution encoder (CE) to increase redundance. The rate of the data arriving in the convolution encoder CE of these code channels can vary from 1.2 to 9.6 kbps, which is why the data leaving the convolution encoder CE is forwarded to a symbol repetition block (SR) which takes care of converting the channels having different rates to a certain rate before block interleaving (BI). On a synchronization channel, this rate is 4.8 kbps and on traffic and paging channels, it is 19.2 kbps. Block interleaving prevents the occurrence of several consecutive burst errors on the same channel. The traffic channel and paging channel signals are encrypted by performing a modulo-2-summing with a long code for each interleaved signal in a data scrambler (DS). The long code is a periodic code sequence created from a 42-bit long-code mask specific to each base station, code channel and paging channel. A long-code generator (LCG) generates from a long-code mask on a 1.2288-MHz frequency a periodic pseudo-random noise sequence (PN sequence), from which every 64^{th} bit is fed into the scrambler by the first decimator (Dec1). On traffic channels, and synchronized by a second decimator Dec2, power control bits for mobile station power control are fed into the signal being transmitted in a multiplexer mux. The signal of each code channel is made orthogonal in relation to the other signals by multiplying each signal by its own Walsh function. After this, the spectrum of the signals is spread (QS, Quadrature Spreading) further by multiplying the signal by the quadrature phases (I and Q signals) of the PN sequence mentioned above. After baseband filtering (BBF), the carrier-modulated BPSK (Binary Phase Shift Keying) components are summed on the forward CDMA channel to produce a QPSK-modulated (Quadrature Phase Shift Keying) signal suitable for transmission.

A preferred embodiment of the invention relates to the definition of the long-code masks described above on the basis of the base station location and to the definition of the long code formed for each code channel on the basis of the mobile station location. FIG. 3 shows a general long-code mask format in the IS-95 system. The Pilot-PN field comprises 9 bits which describe the PN sequence offset value of the forward CDMA channel. A 16-bit base station identifier is entered in the Base-ID field. The paging and traffic channels used are defined in their own 3- and 5-bit fields (PCN, Paging Channel Number, TCN, Traffic Channel Number). The remaining 9 bits are reserved for the Header field of the long-code mask.

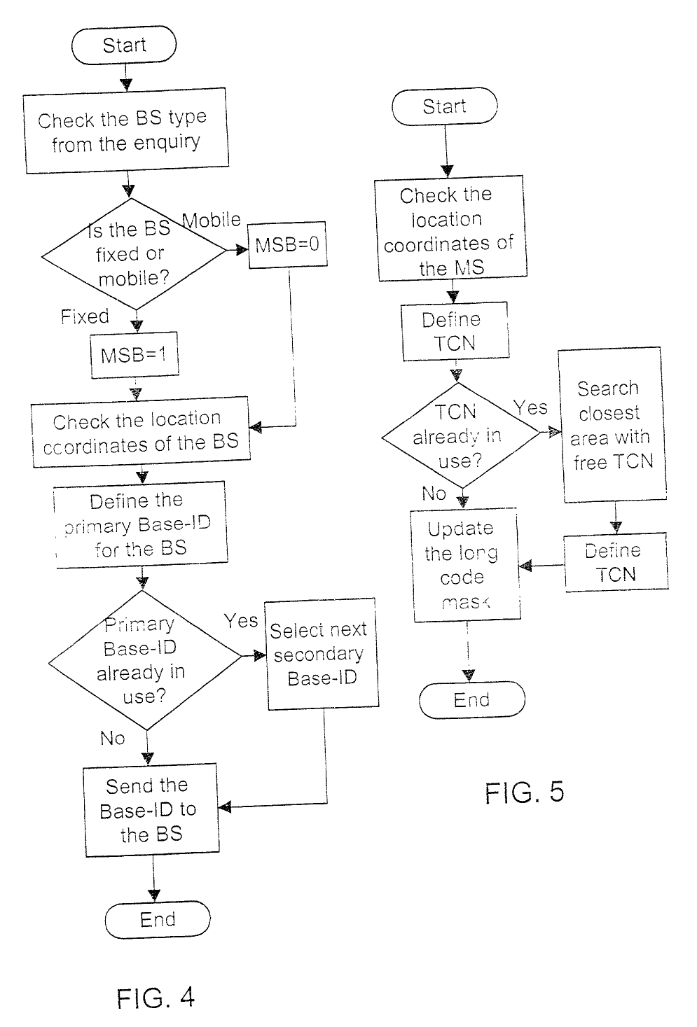

In the following, the implementation of the invention will be described in more detail on the basis of FIG. 4. The block diagram in FIG. 4 illustrates the operation of a mobile telephone switching office MTSO when defining the identifier Base-ID of a base station BS according to a preferred embodiment of the invention. According to a preferred embodiment of the invention, the mobile telephone switching office MTSO maintains a database on the identification data defined for base stations BS. When attempting to connect to a mobile network, a base station BS transmits to the mobile telephone switching office MTSO an enquiry comprising information on whether the base station in question is fixed or mobile. The definition of the identification data is made by first dividing base stations to fixed and mobile base stations, on the basis of which the first bit (MSB) of the identifier Base-ID is defined as 1 or 0, respectively. The definition continues based on the geographical location of the base stations so that the identifier Base-ID is defined for fixed base stations permanently on the basis of the location coordinates of the base station. For mobile base stations, the identifier is defined on the basis of the location coordinates of the base station at the moment the base station connects to the network. This mobile base station identifier can be reset when necessary. Due to the inaccuracy of the positioning system, two closely located base stations BS1 and BS2 may give the same location information to the mobile telephone switching office MTSO, which is why each location information must have a primary identifier and several secondary identifiers. The base station BS communicates its location coordinates to the mobile telephone switching office MTSO which, on the basis of the received location information, checks from its database, whether the primary base station identifier formed for the area in question is free. If it is, the mobile telephone switching office MTSO allocates the free primary identifier to the base station. If the primary identifier is already reserved, any free secondary identifier is allocated to the base station BS. The procedure described above is suitable for both fixed and mobile base stations. In practice, base stations in a fixed mobile network obtain the primary identifier formed for the area and mobile base stations obtain one of the secondary identifiers.

The long-code mask formed for each traffic channel between a base station BS and a mobile station MS is defined on the basis of the channel identifier used. In the following, the definition of a traffic channel identifier performed by a base station BS is described on the basis of the block diagram in FIG. 5. According to a preferred embodiment of the invention, the base station BS allocates a traffic channel (TCN) for the link on the basis of the location of the mobile station MS. This can be done so, for instance, that the base station BS maintains a database which comprises the coverage area, i.e. cell, of the base station defined according to location coordinates, as well as the cell in question divided into sub-sections according to the number of traffic channels, for which sub-sections a primary traffic channel TCN has been defined. When a mobile station MS establishes a connection to a base station BS, the mobile station MS transmits its location coordinates to the base station BS. The base station BS defines a traffic channel TCN corresponding to the location coordinates and checks from the database, whether the primary traffic channel of the cell sub-section comprising the mobile station location coordinates is free. If it is, the free primary traffic channel is allocated to the mobile station MS and, at the same time, the traffic channel identifier TCN is associated with the long-code mask used on the link. If the primary traffic channel is not free, the base station BS tries to allocate to the mobile station MS a traffic channel which primarily belongs to a cell sub-section closest possible to the mobile station MS.

According to one preferred embodiment of the invention, the implementation of the mobile telephone switching office MTSO, base station BS and mobile station MS corresponds to the normal implementation known per se to persons skilled in the art apart from the changes required for the implementation of the invention. Thus, it is obvious that both the base station BS and the mobile station MS comprise for instance a transceiver unit for transmitting signals to each other over the radio path, memory for storing data and a microprocessor for processing data.

A mobile, temporary base station usually forms an overlapping cell with a cellular network formed by fixed base stations. This is not a problem, because the identifier of the base station differs from the identifiers of the fixed base stations and thus the long-code mask formed is also specific for each mobile base station. Which of the overlapping cells the mobile station connects to may cause a problem for network management. Usually, a mobile base station provides a special service, for instance in connection with a local public event. If the mobile station requests this special service from the network, a service identifier specific to the service is added to the request signal, and the mobile switching center knows to direct the mobile station to the correct base station on the basis of the service identifier. In public network services, change of cell, i.e. handover, is performed according to known handover algorithms.

One application of the invention is providing the special services described above as broadcast-type signals which are well suited for use by the authorities or corporations. In such a case, in the area of each cell, where the service in question is provided, one traffic channel is reserved as a broadcast channel on which service signals are transmitted using one code sequence only. The code sequence used in each area is preferably stored in the memory of a mobile station. This way, a mobile station wanting or authorized to use the service in question can, on the basis of its location information, select the correct code sequence to use in receiving broadcast signals and tunes in to listen to the correct channel.

In one preferred embodiment of the invention, location definition according to the invention is performed using satellite positioning. When designing third-generation mobile stations, an idea has arisen to integrate a satellite positioning receiver into the mobile station. According to a preferred embodiment of the invention, a corresponding satellite positioning receiver is also integrated into the base station. One of the most advanced satellite positioning system is called Global Positioning System (GPS). In the following, the operation of the GPS is briefly described. The implementation method of the satellite positioning system is, however, not relevant to the operation of the invention so a description of it is not necessary in this context. It is obvious to persons skilled in the art that any satellite positioning system other than the GPS can also be used for positioning.

The GPS is satellite positioning system operated by the Department of Defence of the United States, which comprises 24 satellites orbiting earth. The orbits and the locations in the orbit of the satellites are designed so that a satellite positioning receiver anywhere can receive a signal from at least five satellites simultaneously. Since an exact positioning requires measuring four dimensions (3 dimensions and time), the signals of four different satellites are used to calculate the position. The GPS satellites transmit their signal on two different frequencies, the L1 frequency of approximately 1.57 GHz meant for civilian use and the L2 frequency of approximately 1.23 GHz meant for military use. With these two signals, two binary timing codes are transmitted, the C/A (Coarse/Adjustment) code on L1 frequency only and the P (Precise) code on both L1 and L2 frequency. By analyzing the two timing codes, the location of a positioning receiver can be defined depending on the level of the receiver at an accuracy of 1 to 100 meters. A more accurate measurement is achieved by first making an analysis on the timing codes and then filtering the timing codes from the signal and defining the Doppler phase offset generated in the signal. Such a measurement is slow to perform (5 to 45 min), but produces millimeter accuracy. The measuring can also be done quickly using reference base stations on the ground, whose exact location is known. In such a case, measuring done in a few seconds provides a location at an accuracy of 2 cm to 1 m depending on the distance to the reference base station. The figures disclosed above illustrate current GPS art, but it is clear that the performance of the system will improve in the future both with respect to measuring accuracy and measuring speed.

The system of the invention facilitates network management and network design in situations where mobile or temporary base stations need to be added to a base station system. The procedure of the invention ensures a different long-code mask and, through it, a different PN sequence for each connection. If necessary, same base station identifiers can be used in long-code masks as long as the distance between two base stations using the same identifier is long enough, i.e. at least twice the diameter of the cell. The base station identifiers used in long-code masks need not be the same as those used by a mobile switching center when managing base stations. It should also be noted that a base station need not necessarily be a base station on the ground, but satellite base stations can also be used in the system.

A network or local parts of it can be installed quickly using the system of the invention. Therefore, a telecommunication network of the invention is particularly well suited for use by the military or the authorities.

The implementation of the invention is not bound to a CDMA system according to the IS-95 standard. The invention can also be implemented in various wideband code division multiple access systems, i.e. WCDMA systems. These WCDMA systems differ somewhat in implementation from the IS-95 system, but for instance the forming of the long-code mask and the code sequences generated from it is, in principle, performed in the same manner. Thus, the invention can also be implemented in WCDMA systems.

The invention can also be implemented in MC-CDMA systems (Multi-Carrier Code Division Multiple Access), in which a CDMA-type spectrum spreading and channel definition on the basis of code sequences is combined with OFDM-based (Orthogonal Frequency Division Multiplexing) multi-carrier modulation. The signals transmitted in an MC-CDMA system are distributed onto the sub-carriers by performing a fast Fourier transformation (FFT) on the signals. A constant-time phase offset is defined for each sub-carrier, the length of which is determined in CDMA manner on the basis of the generated code sequences. Lately, studies have been made on the suitability of the MC-CDMA system for wireless local area networks (WLAN), for instance, to which the invention can also be applied.

The examples, figures and the descriptions related to them are only intended to illustrate the present invention. It is obvious to a person skilled in the art that a detailed implementation of the invention can be made in many different ways within the scope of the accompanying claims.

I claim:

1. A method in a wireless telecommunications system using code division multiple access technology, the system having a telecommunication switching center, a base station and a wireless terminal, the method comprising the steps: defining an identifier for the base station; defining a traffic channel identifier for the radio link traffic channel between said base station and said wireless terminal, the channels of the radio link between the base station and the wireless terminal are distinguished from each other by code sequences, the identifier of the base station is defined on the basis of the location of the base station and the code sequences used on the channels of the radio link are defined on the basis of the location information of the base station and the wireless terminal.

2. A method of claim 1 wherein the traffic channel identifier of the radio link between the base station and the wireless terminal is defined on the basis of the location of the wireless terminal.

3. A method of claim 2 wherein the base station identifier and the traffic channel identifier of the radio link between the base station and the wireless terminal is set as part of a long-code mask.

4. A method of claim 3 wherein at least one traffic channel is used as a broadcast channel, and the same traffic channel identifier is used on the radio link between the base station and all wireless terminals.

5. A method of claim 4 wherein the wireless terminal defines the code sequence to be used on the broadcast channel on the basis of its location.

6. A method of claim 1 or 2 or 3 or 4 or 5 wherein wideband code division multiple access technology (MCDMA) is used on the radio link.

7. A method of claim 1 or 2 or 3 or 4 or 5 wherein OFDM-based (Orthogonal Frequency Division Multiplexing) multi-carrier code division multiple access technology (MC-CDMA) is used on the radio link.

8. A method of claim 1 or 2 or 3 or 4 or 5 wherein the location information of the base station and the wireless terminal are obtained through a satellite positioning system.

9. A wireless telecommunications system using code division multiple access technology, comprising a telecommunication switching center, a base station and a wireless terminal, and in which system the telecommunications switching center is arranged to define an identifier for the base station and which base station is arranged to define a traffic channel identifier for a radio link traffic channel between the base station and the wireless terminal, and in which system the channels of the radio link between the wireless terminal are distinguished from each other by code sequences, the identifier of the base station is defined on the basis of the location of the base station and the code sequences used on the channels of the radio link are defined on the basis of the location information of the base station and the wireless terminal.

10. A telecommunication system as claimed in claim 9 wherein the traffic channel identifier of the radio link between the base station and the wireless terminal is defined on the basis of the location of the wireless terminal.

11. A telecommunication systems as claimed in claim 10 wherein the base station identifier and the traffic channel identifier of the radio link between the base station and the wireless terminal is set as part of a long-code mask.

12. A telecommunication system as claimed in claim 11 wherein at least one traffic channel is defined as a broadcast channel on which the traffic channel identifier of the radio link between the base station and all wireless terminals is the same.

13. A telecommunication system as claimed in claim 12 wherein the wireless terminal is arranged to define the code sequence to be used on the broadcast channel on the basis of its own location.

14. A telecommunication system as claimed in claim 9 or 10 or 11 or 12 or 13 wherein the radio link is arranged to use wideband code division multiple access technology (WCDMA).

15. A telecommunication system as claimed in claim 9, or 10 or 11 or 12 or 13 wherein the radio link is arranged to use an OFDM-based multi-carrier code division multiple access technology (MC-CDMA).

16. A telecommunication system of claim 15 wherein the location information of the base station and the wireless terminal are arranged to be obtained through a satellite positioning system.

17. A base station, such as a base station of a mobile network, using code division multiple access technology, which base station is arranged to define a traffic channel identifier for the traffic channel of a radio link between a base station and a wireless terminal, and which base station is arranged to distinguish the wireless terminals from each other by code sequences, define its own location, to receive a base station identifier defined on the basis of the location of the base station, receive the location information of the wireless terminal and define the code sequence of the radio link between the base station and the wireless terminal on the basis of the location information of the base station and the wireless terminal.

18. A base station of claim 17 wherein the base station uses wideband code division multiple access technology (WCDMA).

19. A base station of claim 17 wherein the base station uses OFDM-based multi-carrier code division multiple access technology (MC-CDMA).

20. A base station of claim 17 or 18 or 19 wherein the base station is arranged to define its location information through a satellite positioning system.
